(19) United States
(12) Patent Application Publication
(10) Pub. No.: US 2003/0144826 A1
(43) Pub. Date: Jul. 31, 2003

(54) Register repositioning method for functional verification systems

(76) Inventors: Michael I. Mandell, Los Angeles, CA (US); Timothy Koehler, Redondo Beach, CA (US); Arnold L. Berman, Los Angeles, CA (US)

Correspondence Address: HARNESS, DICKEY & PIERCE, P.L.C., P.O. BOX 828, BLOOMFIELD HILLS, MI, 48303, US

(21) Appl. No.: 10/059,751

(22) Filed: Jan. 29, 2002

(51) Int. Cl. G06F 17/50

(52) U.S. Cl. 703/14

(57) ABSTRACT

A method and computer system formally verifies a synthesis of integrated circuit designs that include pipeline registers. A hardware description language (HDL) representation of an integrated circuit is parsed. Components and connections of the HDL representation are identified. Pipeline register components of the HDL representation are removed. The removed pipeline register components are replaced with a conductor. Pipeline register components are added between output logic gates and output registers of the HDL representation to create a new HDL representation. Formal verification of the new HDL representation is performed using a verification tool.

### FIELD OF THE INVENTION

The present invention relates to integrated circuit verification systems, and more particularly to formal verification systems for integrated circuits with pipeline registers.

### BACKGROUND OF THE INVENTION

There are two primary methods that currently exist for verifying the synthesis of an integrated circuit design. One method involves running software simulations on the design. Simulations can be performed on any integrated circuit design. The size of modern integrated circuits such as application specific integrated circuits (ASICs), usually prevents an exhaustive test of the integrated circuit design. When judicious test cases are selected, the results of the simulations can approach the results of a formal verification. Nonetheless, simulations cannot provide the formal verification of the integrated circuit design.

A second method can be used for formal verification of the integrated circuit design. This method involves an exhaustive mathematical proof that establishes whether two designs are logically equivalent. While providing the benefits of a complete proof, formal verification is not used as frequently as simulations. Formal verification cannot handle integrated circuits with certain types of circuit components.

Many modern complex circuit designs such as ASICs contain pipeline registers. Formal verification methods are not able to verify designs that contain pipeline registers. Since many integrated circuit designs run at high frequencies that require pipeline registers, formal verification tools cannot be used to provide the formal verification.

In U.S. Pat. No. 6,077,303 to Mandell et al. and my co-pending applications “Architectural Structure Of A Process Netlist Design Tool”, Ser. No. 09/880,444, filed Jun. 13, 2001 and “Marker Augmentation For An Integrated Circuit Design Tool and File Structure”, Ser. No. 09/928,848, filed Aug. 13, 2001, which are hereby incorporated by reference, a design tool and method for verifying the design of ASICs is disclosed. In Mandell et al. '303, a method is disclosed for verifying that a system that is built from smaller components implements a desired equation that represents the system. Symbolic data is clocked through the system by processing a symbolic test vector using linked equations that are written for each component of the system. The resulting symbolic equation, generated at the output of the system, is stored. The symbolic equation is then compared with the desired equation for the system using a symbolic manipulation tool. If the comparison generates a zero difference, the system correctly implements the desired equation that correctly represents the system.

### SUMMARY OF THE INVENTION

A method and system according to the present invention formally verifies a synthesis of integrated circuit designs that include pipeline registers. A hardware description language (HDL) representation of an integrated circuit is parsed. Components and connections of the HDL representation are identified. Pipeline register components of the HDL representation are removed.

In other features of the invention, the removed pipeline register components are replaced with a conductor. Pipeline register components are added between output logic gates and output registers of the HDL representation to create a new HDL representation. Formal verification of the new HDL representation is performed using a verification tool.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates an exemplary integrated circuit representation that includes pipeline registers;

FIG. 2 is a synthesized integrated circuit representation;

FIG. 3 is the synthesized integrated circuit representation of FIG. 2 with nodes labeled;

FIG. 4 is a logically equivalent representation to FIG. 3 in which the pipeline registers are removed and replaced between the output registers and preceding logic according to the invention;

FIG. 5 illustrates a method for repositioning pipeline registers according to the present invention; and

FIG. 6 illustrates a computer system including a register repositioning tool and a verification tool.

### DETAILED DESCRIPTION OF THE PREFERRED EMBODIMENTS

The following description of the preferred embodiment(s) is merely exemplary in nature and is in no way intended to limit the invention, its application, or uses.

Formal verification of integrated circuits such as application specific integrated circuits (ASICs) takes significantly less time than would otherwise be spent on simulations. The present invention provides a method for formally verifying a synthesis of integrated circuits designs that include pipeline registers. As a result of this method, the amount of time that is required to design these integrated circuits can be significantly reduced.

Referring now to FIG. 1, an integrated circuit representation 10 is shown. The design may be initially hand-drawn or coded directly into a hardware description language (HDL), such as VHDL (VHSIC Hardware Description Language), Verilog Hardware Description Language and the like. Each language has its own syntax, control flow constructs, and other functionality. VHDL is specified by IEEE Std. 1164-1993. The integrated circuit representation 10 is shown in resistor-transistor logic (RTL) VHDL.

The integrated circuit representation 10 includes input registers 12-1 and 12-2, logic 14, pipeline registers 16-1 and 16-2, and output registers 20-1 and 20-2. In the integrated circuit representation 10, the pipeline registers 16 are connected between the logic 14 and the output registers 20.

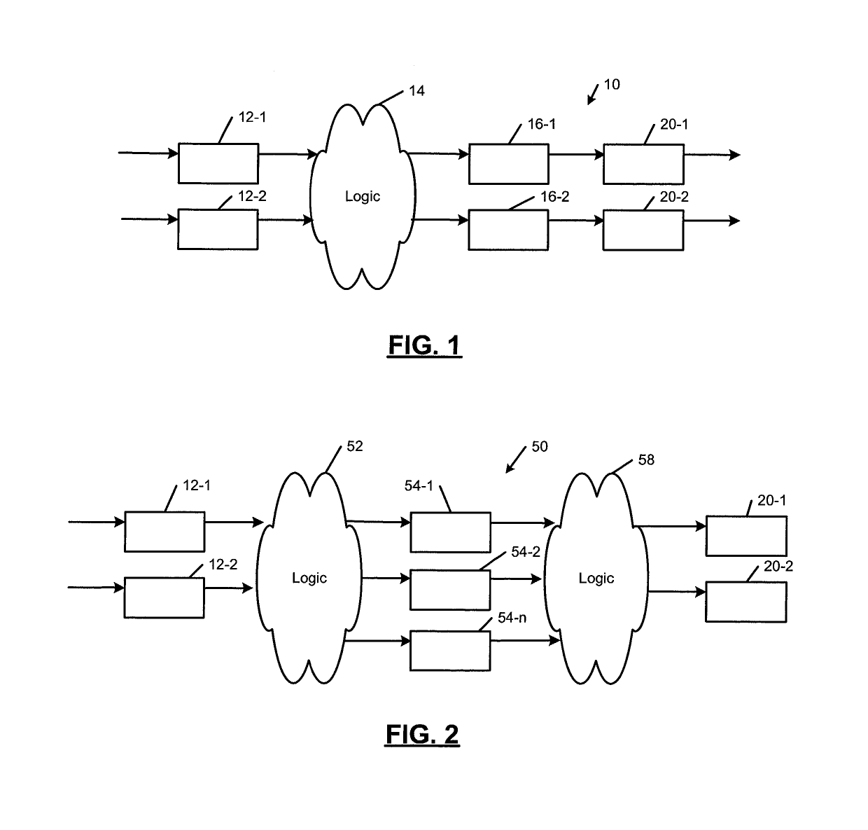

To place the pipeline registers 16 as needed throughout the design, conventional VHDL synthesis tools employ a register repositioning technique. After register repositioning and synthesis, the integrated circuit representation 10 of FIG. 1 may look similar to an integrated circuit representation 50 in FIG. 2. For purposes of clarity, reference numbers from FIG. 1 are used in FIG. 2 to identify similar elements. The integrated circuit representation 50 includes logic 52 that is connected to input registers 12 and pipeline registers 54-1, 54-2, . . . , 54-n. The pipeline registers 54 are connected to logic 58 that is connected to output registers 20.

Formal verification tools compare the RTL VHDL integrated circuit representation 10 to the synthesized integrated circuit representation 50. The position of the logic gates with respect to the pipeline registers after synthesis is different than the original integrated circuit representation 10. Also, there may be a different number of pipeline registers in the synthesized integrated circuit representation after register repositioning is performed.

Formal verification tools initially match registers in the two designs. Then, the formal verification tools analyze the logic between the register stages. Since logic between register stages is different in the representations in FIGS. 1 and 2, formal verification tools will fail to find logical equivalence. To solve this problem, the present invention analyzes the gate-level design and modifies it to maintain functional equivalency. The present invention places the pipeline registers in a manner that is compatible with formal verification tools.

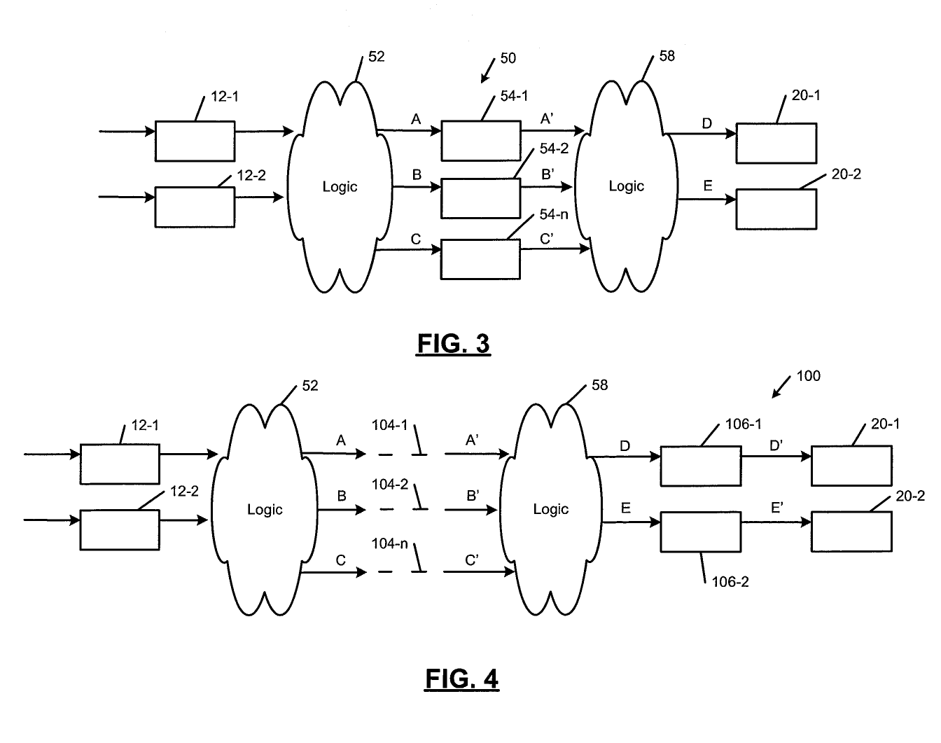

Referring now to FIG. 3, nodes of the integrated circuit representation 50 are labeled A, A′, B, B′, C, C′, D, and E. Reference numbers from FIG. 2 are used in FIG. 3 where appropriate to identify similar elements. Nodes A, B and C are outputs of logic 52. Nodes A′, B′ and C′ are outputs of pipeline registers 54. Nodes D and E are outputs of logic 58 and are connected to output registers 20-1 and 20-2. Since a pipeline register merely holds a signal for a clock cycle, it is logically equivalent to substitute a wire or conductor for the pipeline register. In other words, timing is not a consideration for logical equivalency.

Referring now to FIG. 4, a logically equivalent integrated circuit representation 100 is shown. For purposes of clarity, reference numbers from FIG. 3 are used in FIG. 4 where appropriate to identify similar elements. The integrated circuit representation 100 is similar to the integrated circuit representation 50 except that the pipeline registers 54 have been removed and replaced by wires or conductors 104-1, 104-2, . . . , and 104-n. In addition, an appropriate number of pipeline registers 106-1 and 106-2 are added between the nodes D and E and output registers 20-1 and 20-2.

Referring now to FIG. 5, steps for repositioning pipeline registers such as pipeline registers 54 for functional verification tools is illustrated. In step 120, the HDL such as VHDL of a gate level design is parsed. In step 122, connections between components of the gate level design are identified. In step 124, the number of pipeline stages is counted. In step 128, the pipeline registers are removed and replaced with a wire or conductor. In step 132, an appropriate number of pipeline registers are added between output logic gates and output registers. In step 140, functional verification is performed by the formal verification tool.

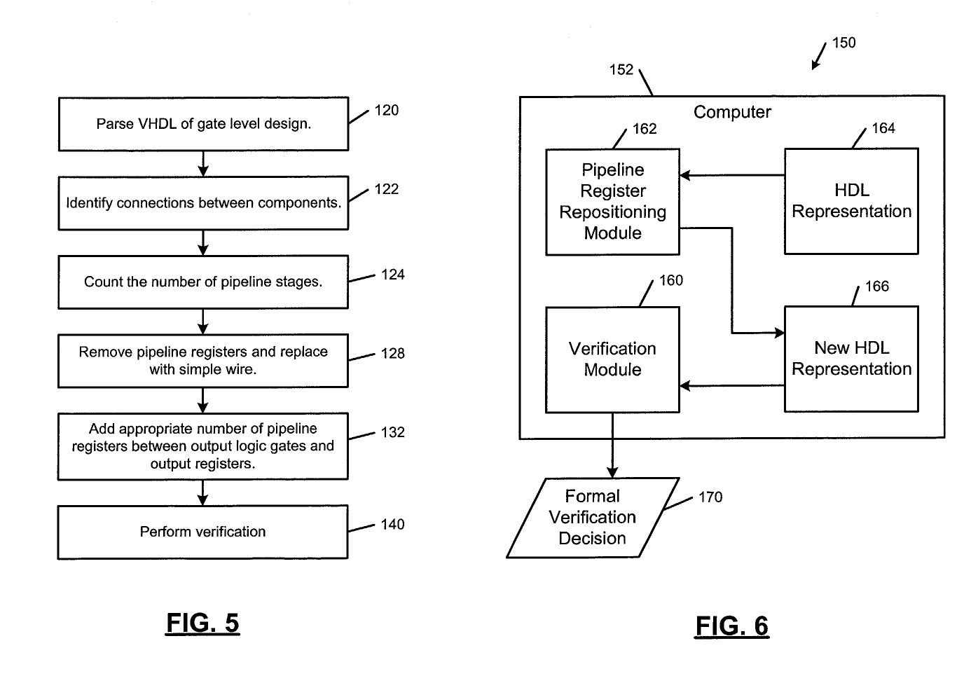

Referring now to FIG. 6, a computer system 150 formally verifies a synthesis of integrated circuit designs that include pipeline registers. The computer system 150 includes a computer 152 including a processor and memory such as read only memory, random access memory, flash memory or other suitable electronic storage (not shown). A verification module 160 is executed by said computer 152 and performs formal verification. A pipeline register repositioning module 162 removes pipeline register components of a hardware description language (HDL) representation 164. The pipeline register repositioning module 162 replaces the removed pipeline register components with a conductor or wire. The pipeline register repositioning module 162 adds at least one pipeline register component between output logic gates and output registers of the HDL representation 164 to create a new HDL representation 166, as previously described above. The verification module 160 formally verifies the new HDL representation and generates a formal verification decision 170.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A method for formally verifying a synthesis of an integrated circuit design that includes at least one pipeline register, comprising:
parsing a hardware description language (HDL) representation of a said integrated circuit design;
identifying components of said HDL representation;
identifying connections between said components of said HDL representation; and
removing at least one pipeline register component of said HDL representation.

2. The method of claim 1 further comprising replacing said at least one removed pipeline register component with a conductor.

3. The method of claim 2 further comprising adding at least one pipeline register component between output logic gates and output registers of said HDL representation to create a new HDL representation.

4. The method of claim 3 further comprising performing formal verification of said new HDL representation.

5. The method of claim 1 wherein said integrated circuit is an application specific integrated circuit.

6. A computer system that formally verifies a synthesis of an integrated circuit design that includes at least one pipeline register, comprising:
a computer including a processor and memory; and
a pipeline register repositioning module that is executed by said computer and that parses a hardware description language (HDL) representation of an integrated circuit, identifies components of said HDL representation and connections between said components of said HDL representation, and removes at least one pipeline register component of said HDL representation.

7. The computer system of claim 6 wherein said module replaces at least one of said removed pipeline register components with a conductor.

8. The computer system of claim 7 further wherein said pipeline register repositioning module adds at least one pipeline register component between output logic gates and output registers of said HDL representation to create a new HDL representation.

9. The computer system of claim 8 further comprising a verification module executed by said computer that performs formal verification of said new HDL representation.

10. The computer system of claim 6 wherein said integrated circuit is an application specific integrated circuit.

11. A method for formally verifying a synthesis of an integrated circuit design that includes at least one pipeline register, comprising:
removing said at least one pipeline register component of a hardware description language (HDL) representation of said integrated circuit; and
replacing said removed pipeline register component with a conductor;
adding at least one pipeline register component between output logic gates and output registers of said HDL representation to create a new HDL representation.

12. The method of claim 11 further comprising:
parsing said HDL representation of said integrated circuit;
identifying components of said HDL representation; and
identifying connections between said components of said HDL representation.

13. The method of claim 12 further comprising performing formal verification of said new HDL representation.

14. The method of claim 11 wherein said integrated circuit is an application specific integrated circuit.

15. A computer system that formally verifies a synthesis of an integrated circuit design that includes pipeline registers, comprising:
a computer including a processor and memory;
a verification module that is executed by said computer and that performs formal verification;
a pipeline register repositioning module removes at least one pipeline register component of a hardware description level (HDL) representation, replaces said removed pipeline register component with a conductor, and adds at least one pipeline register component between output logic gates and output registers of said HDL representation to create a new HDL representation,
wherein said verification module formally verifies said new HDL representation.

16. The computer system of claim 15 wherein said integrated circuit is an application specific integrated circuit.
